(19) United States
(12) Patent Application Publication
(10) Pub. No.: US 2020/0222835 A1
(43) Pub. Date: Jul. 16, 2020

(54) Filter element assembly with sealing element and filter system

(71) Applicant: MANN+HUMMEL GmbH, Ludwigsburg (DE)

(72) Inventors: Robert Hasenfratz, Schwaebisch Hall (DE); Fabian Wagner, Moeglingen (DE); Andre Roesgen, Remshalden (DE); Christian Thalmann, Speyer (DE); Frank Pflueger, Sachsenheim (DE); Arndt-Udo Rolle, Stuttgart (DE)

(21) Appl. No.: 16/832,375

(22) Filed: Mar. 27, 2020

Related U.S. Application Data
(63) Continuation of application No. PCT/EP2017/067958, filed on Jul. 17, 2017.

(30) Foreign Application Priority Data
Aug. 16, 2016 (DE) 10 2016 009 844.9

(51) Int. Cl. B01D 35/30; B01D 35/00

(52) U.S. Cl. CPC B01D 35/301; B01D 2201/304; B01D 2257/80; B01D 35/005

(57) ABSTRACT

The invention relates to a filter element assembly for filtering a fluid, optionally including water separation. A filter element has at least one annular filter bellows which is flowed through in the radial direction, and at least one end plate arranged on the filter bellows on the end side. At least one circumferential sealing element is arranged on the end plate. The sealing element seals the clean side from the raw side of the filter element. The sealing element is compressed between a first housing part and a second housing part of the filter system, sealing a housing interior from the environment. The invention also relates to a filter system having the filter element assembly with the sealing element.

### TECHNICAL FIELD

The invention relates to a filter element assembly having at least one sealing element for filtering fuel using water separation, in particular for use as an oil or fuel filter of an internal combustion engine of a motor vehicle, and a filter system with such a filter element assembly.

### BACKGROUND

This section discusses background, as related to the present application. It is to be noted that not all the information presented here is prior art, but is provided for better understanding of the problem to be solved.

EP 2099544 B1 discloses an exchangeable filter insert in an oil filter. The oil filter comprises a filter housing that can be split along a separating surface and the corresponding exchangeable filter insert. Two housing parts of the filter housing are sealed against one another along the separating surface by means of a sealing element. The sealing element is captively attached to the filter insert.

The housing seal and the filter insert form a structural unit that is replaced as a whole within the prescribed maintenance intervals. With the removal of the old filter insert and the installation of the new filter insert, the assembly in one structural unit inevitably means that the seal is also replaced. This prevents the latter from being reused or forgotten during assembly.

The unit consisting of filter insert and sealing element must be adapted exactly to the contour of the filter housing due to the system. The installation of filter cartridges with a different design, which may not correspond to the operating regulations, is difficult or even impossible. Rather, it is ensured that, due to the geometric interplay of the filter housing with the sealing element, only the exactly fitting, correct filter insert can be installed. The confusion-free exchange of the filter insert is simplified and the operational safety of the motor vehicle or its internal combustion engine is increased.

### DISCLOSURE OF THE INVENTION

It is therefore an object of the invention to provide a filter element arrangement for filtering fuel using water separation, which enables a tolerant yet permanent seal in a filter housing.

A further object of the invention is to create a filter system for filtering fuel using water separation, which enables a tolerant yet permanent seal between a raw area and a clean area of the filter system.

According to one aspect of the invention, the aforementioned objects are achieved by a filter element assembly, in particular for filtering fuel, preferably using water separation, which comprises at least one filter element with at least one end plate arranged of the filter bellows on the end side, on which a circumferential sealing element is arranged. When used as intended, the sealing element is provided in a filter system for sealing the clean side against the raw side of the filter element and under compression between a first housing part and a second housing part of the filter system for sealing a housing interior of the filter system against an environment of the filter system.

Favorable embodiments and advantages of the invention are disclosed in the further claims, the description and the drawings.

A filter element arrangement is proposed, in particular for filtering fuel, preferably using water separation, comprising a filter element having at least one annular filter bellows which is flowed through in the radial direction, and at least one end plate arranged on the filter bellows on the end side, as well as at least one sealing element arranged on the end plate. When used as intended, the sealing element is provided in a filter system for sealing the clean side against the raw side of the filter element and under compression between a first housing part of the filter system and a second housing part of the filter system for sealing a housing interior of the filter system against an environment of the filter system. The filter element assembly according to the invention has a sealing element on the filter element, which makes it possible to seal plastic housings with radial tolerances and dimensional changes more reliably over the service life than with conventional O-rings, without having to provide complex positioning arrangements or tests when installing the filter element with the sealing device. The reliable sealing effect is achieved in that the sealing element can be designed, for example, in the form of a molded seal which can be arranged on a radial outside of the end plate and can be supported radially inwards from the radially outer contact side of the end plate. When the filter element is inserted into a filter housing, this molded seal seals against the filter housing, so that the raw side is separated from the clean side of the filter element. Furthermore, the molded seal is able to seal both housing parts of the filter housing by pressing the sealing element against one another and against the environment, so that a housing interior of the filter system is sealed against an environment of the filter system. This is achieved in that different sealing surfaces of the molded seal abut sealingly against corresponding sealing surfaces of the housing parts. The molded seal can be pressed axially and radially in order to reliably exert its sealing effect.

The sealing element in the form of a molded seal can be fitted directly onto the contact side of the end plate of the filter element or can be firmly connected to it. The end plate forms the seal carrier. In this way it can be ensured that the sealing element maintains its desired position when the filter element is installed in the filter housing and does not twist or slip. This also allows a certain tolerance compensation for tolerances in the manufacture of the filter housing and in the manufacture of the filter element. According to an advantageous embodiment of the filter element arrangement, the sealing element can be arranged on the intended lower end plate. This can advantageously be used to seal a clean side water separation, in which water is collected in a water collecting space at the intended lower end of the filter element.

According to an advantageous embodiment, the intended lower end plate on which the sealing element is arranged can have a water discharge opening for separated water. This allows a compact arrangement and can advantageously be used to seal a water separation on the clean side, in which water is collected in a water collecting space at the intended lower end of the filter element.

According to an advantageous embodiment, a further sealing element for sealing between the clean side and the raw side of the filter element can be provided in the region of the end face of the filter bellows, which is opposite the intended lower end plate. This enables a compact design and improved sealing properties of the filter element assembly. The end face of the filter bellows opposite the intended lower end plate can, for example, have an end plate on which the further sealing element can be arranged. The further sealing element can be, for example, a round cord ring. The further sealing element can be arranged radially within a clear width of the filter bellows. The further sealing element can be aligned with the end face of the filter bellows or be slightly offset, in particular positioned slightly above the end face of the filter bellows. Conveniently, the additional sealing element allows the filter element to be pushed onto a connector which is fixed to the housing and which engages in the interior of the filter bellows when it is inserted into the housing.

According to an advantageous embodiment, the sealing element can be provided on the intended lower end plate for sealing the raw side against a clean-side water collecting space. When replacing the filter element, contamination of the clean side can optionally be reduced or avoided.

According to an advantageous embodiment, the intended lower end disk can have a contact surface for axial contact with one of the housing parts, which can be offset radially inwards opposite an elastic sealing material of the sealing element. The contact surface for axial contact can be provided, in particular, on the outer end face of the intended lower end plate. With a differential pressure between the raw side and the clean side, an axial movement of the filter element can advantageously be limited. The sealing element can either be releasably attached or captively attached to the end plate.

According to an advantageous embodiment, the sealing element can be captively connected to the intended lower end plate. Fewer components are required. The installation of the filter element is simplified. The sealing element can advantageously be glued to the end plate or vulcanized onto the end plate. Alternatively, the sealing element can be detachably fastened, for example only be pulled on.

According to an advantageous embodiment, the sealing element can be a sealing element which, with at least one radially inner surface, lies sealingly against a radially outer contact side of the end plate. This ensures that the sealing element seals against the end plate and is reliably sealed when installed in a filter housing between the raw side and the clean side of the filter element. In particular, the sealing element can be designed as a sealing element without a seal carrier, the sealing element being arranged directly on the abutment side of the end plate and being, for example, firmly connected to the end plate, for example glued or vulcanized to it. Optionally, the sealing element can also simply be pulled onto the end plate.

The sealing element can have tabs which enable the sealing element to be changed easily. Furthermore, the sealing element can be connected via coupling elements to one of the two housing parts, preferably the cover or the housing part located at the top during upright assembly, which is advantageous in a service-friendly maintenance process, since the sealing element can remain in the unscrewed cover of the filter housing. The coupling elements can have snap-in or latching elements which also acoustically signal correct assembly.

According to an advantageous embodiment, the sealing element can have at least two sealing surfaces, one of which is provided in the installed state in a filter system for contacting each of the two housing parts. By designing the sealing element with at least two sealing surfaces, the tolerance situation can be checked more easily, since the sealing to each individual housing part can take place independently of the sealing to the respective other housing part. The sealing material has the necessary deformability.

According to an advantageous embodiment, the two sealing surfaces can extend at least in sections inclined to a longitudinal axis of the filter element. The two sealing surfaces can run at an angle to each other and to the longitudinal axis of the filter element, since the sealing element can be pressed both axially and radially when the filter element is inserted in the filter housing and the two housing parts are closed, which results in a reliable and tolerance-compensating seal of the filter element and the filter system.

According to an advantageous embodiment, an expansion of the sealing element in the uncompressed state in the axial direction can be greater than an expansion of the sealing element in the radial direction. Since an axial pressure component on the sealing element is greater than a radial pressure component when the filter element is inserted and then closed, it is advantageous if the sealing element has a greater extent in the axial direction and can thus accommodate a greater change in length.

According to an advantageous embodiment, the inner surface of the sealing element can be firmly connected to the contact side of the end plate, the sealing element in particular being vulcanized onto the contact side. It is expedient if the sealing element is arranged directly on the outside of the end plate, since a reliable and permanent seal between the sealing element and the end plate can be achieved in this way. The sealing element also does not change its position when the filter element is installed in a filter housing, which also has a favorable effect on the sealing effect on the filter housing. In addition, for example, vulcanizing the sealing element onto the end plate represents a very inexpensive and process-favorable possibility of firmly connecting the sealing element to the end plate, which simplifies the manufacture of the filter element.

According to an advantageous embodiment, the sealing element on the inner surface can have at least one holding contour for fixing the sealing element on the contact side, which holding contour engages in a corresponding counter-contour on the contact side. The sealing element can be axially secured against displacement of the sealing element during installation in the filter housing with the aid of the holding contour. By engaging the holding contour in a corresponding counter-contour in the outside of the end plate, a secure connection between the sealing element and the end plate can be created. Optionally, the connection for replacing the sealing element can be released again in the event of service, which is not, however, absolutely necessary.

According to an advantageous embodiment, the at least one holding contour of the sealing element can have one or more latching elements which engage in corresponding recesses on the contact side of the end plate. Locking the sealing element with the end plate establishes a secure connection between the two components. In addition, a haptic reaction for secure mounting of the sealing element on the end plate can also be realized via the latching, which contributes to a reliable attachment of the sealing element to the end plate.

According to a further aspect, the invention relates to a filter system for filtering a fluid, in particular for filtering fuel, preferably with a water separating unit, comprising a filter element arrangement with an exchangeable filter element, which comprises at least one annular filter bellows which can be flowed through in particular and at least one end disk arranged on the end face of the filter bellows, as well as with a circumferential sealing element arranged on the end plate. The filter system further comprises a filter housing, comprising a first housing part and a second housing part, the filter element being arranged in at least one of the housing parts. In this case, a sealing element is arranged on a radially outer contact side of an intended lower end plate and is supported radially inward from the contact side. The sealing element is provided for sealing the clean side against the raw side of the filter element and is provided under compression between the first housing part and the second housing part for sealing a housing interior of the filter system against an environment of the filter system.

According to an advantageous embodiment, the sealing element can be pressed axially and radially in the installed state with the filter housing closed. The sealing element is initially axially pressed by the axial approach of the two housing parts, while at the same time sealing surfaces of the sealing element arranged obliquely to the longitudinal axis are pressed radially inwards and thus bring about a radial pressing of the sealing element, since the sealing element can abut evenly against an inner surface on its counter surface, a contact side of the end plate, and is supported radially outwards from the contact side. This gives one a self-reinforcing sealing system that does not require any further mechanical pressing. The sealing element does not serve as a stop when the filter housing is closed. Rather, a mechanical stop is expediently provided on the filter housing, which is closed, for example, by means of a screw thread, so that the screw connection can only take place until the two housing parts abut against the stop. The sealing element can only be pressed to a certain degree in a precisely defined manner so that a reliable and permanent sealing function is guaranteed. The sealing element is thus in a state of equilibrium.

The sealing element is also centered during assembly in the first housing part and when the filter housing is closed by the second housing part itself. Especially when used as an oil filter of an internal combustion engine in a motor vehicle, in which the interior of the housing is pressurized and where the sealing element is should reliably work at temperatures from −40° C. to 150° C. with pressures of up to 4.5 bar and peaks of up to 25 bar, such a self-centering sealing system should be of great advantage, since even with mechanical pumping of the filter housing due to changing pressure conditions, the sealing function is maintained and guaranteed.

An interface between the first housing part and the second housing part of the filter housing is sealed off from the environment via the sealing element, the interface with the sealing element not having to coincide with an interface, for example for screwing or clipping. The two interfaces can also be spatially separated axially, which can even be a significant advantage for the stability of the sealing of the filter housing. The functions of mechanically closing the filter housing and sealing are thus separated from one another.

The sealing element can be a sealing element without a seal carrier, the sealing element abutting with its inner surface directly against the contact side of the end plate. According to an advantageous embodiment, the sealing element can be chambered between the first housing part, the second housing part and the intended lower end plate. The chambering is expediently brought about by a sealing surface abutting against a component sealing surface of the first housing part, a sealing surface abutting against a component sealing surface of the second housing part and an inner surface of the seal bearing against the abutment side of the end plate, wherein the sealing element can be arranged in the installed state in a sealing groove formed from the component sealing surface and an inner wall.

According to an advantageous embodiment, the sealing element can protrude in the axial direction from a sealing groove of the first and/or second housing part. In particular, the sealing element can protrude from a sealing groove of the first and/or second housing part in the compressed state. In this way, the inner wall of the sealing groove covers an axial extent of the sealing element at most by only half, preferably at most by one third. Furthermore, the groove depth of the sealing groove extends only partially over a component sealing surface on the same housing part. Particularly when the sealing element is in the sealing, that is to say compressed state, the sealing element protrudes from a sealing groove in the axial direction. The sealing element advantageously protrudes at least 50%, in particular 70%, and very particularly advantageously 80% of its axial extent in the compressed state from the sealing groove. In this way, a reliable and permanent sealing function of the sealing element is guaranteed. Typically, about a quarter of the axial extent of the sealing element should be available for pressing the sealing element.

According to an advantageous embodiment, the sealing element can have a base part and at least one axial protrusion, the base part abutting on the radially inner surface on the radially outer contact side of the end plate and at least in the compressed state being supported radially inwards from the contact side. In the compressed state, the inner surface can advantageously have an axial extent of at least 50% of the axial extent of the sealing element. In this way, the two functions of supporting the sealing element in the radial direction and performing the actual sealing function in separate components are realized. All radial forces on the sealing element can thus be absorbed via the end plate.

According to an advantageous embodiment, the at least one axial protrusion can be provided for bearing against a component sealing surface of the first housing part or against a component sealing surface of the second housing part. The axial protrusion can thus be designed to perform a sealing function together with the component sealing surface. The radial support function of the sealing element can be implemented separately.

According to an advantageous embodiment, a component sealing surface of one housing part can be arranged in the axial direction outside the sealing groove of the other housing component, which allows greater freedom of design in the attachment of the sealing groove in one of the two housing parts.

According to an advantageous embodiment, the sealing element can have at least two sealing surfaces, one of which is provided in the installed state in the filter system for contacting each of the two housing parts. By designing the sealing element with at least two sealing surfaces, the tolerance situation can be checked more easily, since the sealing to each individual housing part can take place independently of the sealing to the respective other housing part. The sealing material has the necessary deformability.

According to an advantageous embodiment, a further sealing element for sealing between the clean side and the raw side of the filter element can be provided in the region of the end face of the filter bellows, which is opposite the intended lower end plate. In particular, the further sealing element can be provided in the region of the end face of the filter bellows, which is opposite the intended lower end plate. When inserted into the housing, the filter system can be pushed onto a connection piece fixed to the housing, against which the filter element can be sealed with the further sealing element. The further sealing element can advantageously be a round cord ring.

The invention preferably relates to the use of the filter system as an oil or fuel filter. With these fluid filters, it is usually necessary to replace the filter element after a predetermined mileage, so that the filter system is opened at regular intervals and the filter element removed, and a new filter element has to be inserted. With the sealing element according to the invention, it is advantageously possible to replace the sealing element reliably and in a maintenance-friendly manner. Permanent sealing of the filter system after changing the filter element is thus advantageously possible. Since the filter element and sealing element are expediently stored in a service unit and made available for maintenance, it is also ensured that the correct sealing element is used when changing the filter element.

### BRIEF DESCRIPTION OF THE DRAWINGS

Further advantages arise from the following drawing description. Embodiments of the invention are illustrated in the drawings. The drawings, the description and the claims contain numerous features in combination. A person skilled in the art will also expediently consider the features on an individual basis and combine them into other appropriate combinations.

The drawing show by way of example:

FIG. 1 is a sectional view of a filter system according to an exemplary embodiment of the invention;

FIG. 2 is a longitudinal section of a sealing element according to an embodiment of the invention;

FIG. 3 is a schematic sectional illustration of a filter system with focus on the sealing element in the uncompressed state;

FIG. 4 is a schematic sectional illustration of the filter system from FIG. 3 with focus on the sealing element in the compressed state;

FIG. 5 is a longitudinal section of a filter system according to a further exemplary embodiment of the invention with focus on the sealing element; and

FIG. 6 is a longitudinal section of a filter system according to another embodiment of the invention with focus on the sealing element.

### EMBODIMENT(S) OF THE INVENTION

The same or similar components in the figures are referenced with same reference characters. The figures merely illustrate examples and shall not be construed as limiting.

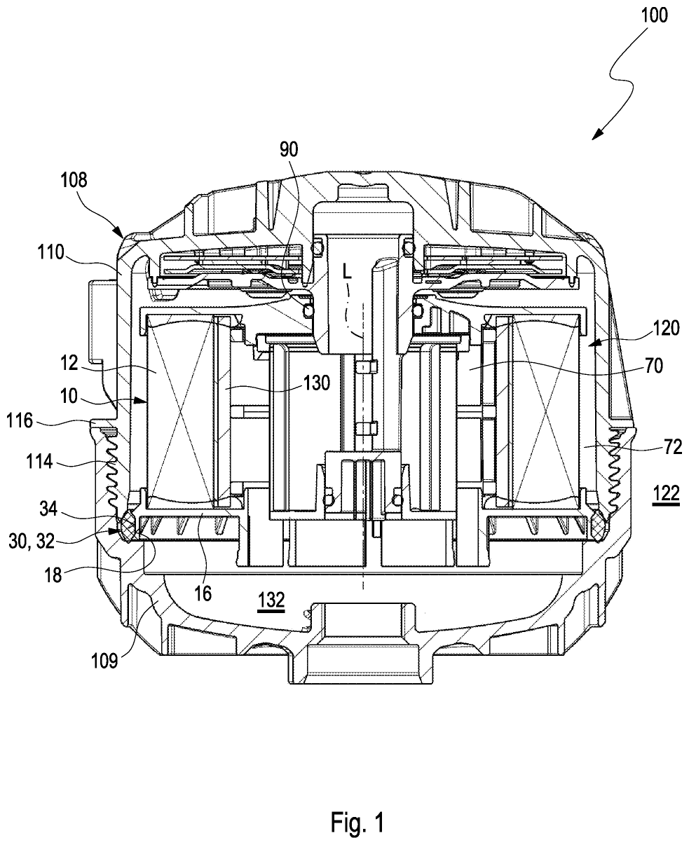

FIG. 1 shows a sectional view of a filter system 100 according to an embodiment of the invention. The filter system 100 is provided in particular for filtering fuel, preferably with a water separation unit. Optionally, the filter system 100 can also be provided for another liquid.

The filter system 100 for filtering a fluid comprises a filter housing 108 with a first housing part 109 and a second housing part 110, in which a filter element assembly with a filter element 10 is arranged, which has an intended lower end plate 16 and on the end face opposite the intended lower end plate 16 of the filter element 10, a further end plate, which is open in the interior and through which an unspecified, clean-side connector engages in the interior of the filter element 10.

The two housing parts 109, 110 are connected to one another via a screw thread 114, the second housing part 110 being screwed onto the first housing part 109 up to a stop 116. The filter element 10, which is provided for filtering fuel using water separation, has a filter bellows 12 which is closed with the intended lower end plate 16. The radially flowable filter bellows 12 is designed as a hollow cylinder, wherein a fluid flow runs from the raw side 72 in the housing interior 120 through the outside of the filter bellows 12 radially inward to the clean side 70 and can be removed through the nozzle from the filter element 10 axially in the direction of filtering the fluid a longitudinal axis L of the filter element 10. A coalescer element 130 is arranged on the radial inside of the filter bellows 12 and is provided for water separation from the fuel. The separated water is collected in the water collecting space 132 of the first housing part 109 and can be drained out of it if necessary. For this purpose, the intended lower end plate 16 has an unspecified water discharge opening for separated water.

A sealing element 30 in the form of a molded seal 32 is arranged on a radial outer circumference of the intended lower end plate 16, the sealing element 30 having a radially inner surface 18 being arranged on a radially outer contact side 34 of the end plate 16 and being supported radially inward from the contact side 34. The sealing element 30 is provided for sealing the clean side 70 against the raw side 72 of the filter element 10 and the first housing part 109 and the second housing part 110 of the filter system 100 against the external environment 122. For this purpose, the sealing element 30 is chambered between the first housing part 109, the second housing part 110 and the end plate 16.

In the area of the end face of the filter bellows 12, which is opposite the intended lower end disk 16, a further sealing element 90 is provided for sealing between the clean side 70 and the raw side 72 of the filter element 10. This can be designed as a round cord ring and seals between the filter element 10 and the unspecified clean-side connector.

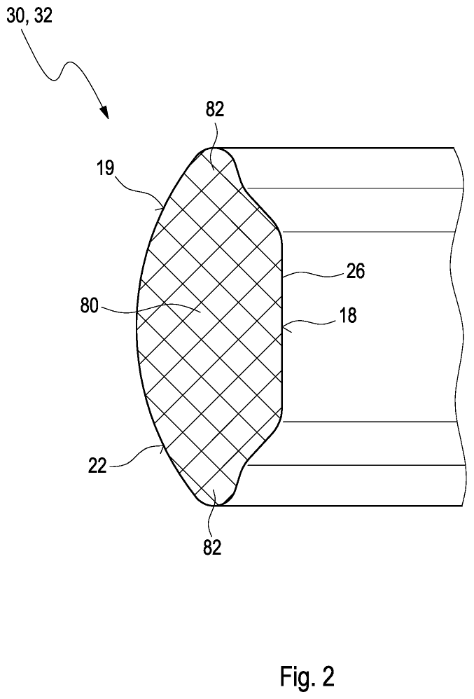

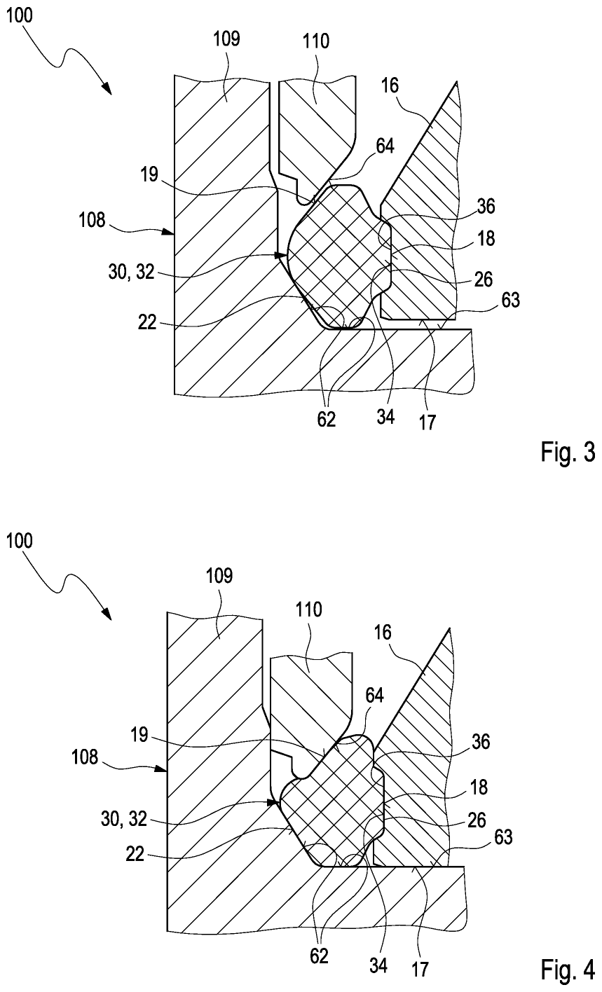

FIG. 2 shows a longitudinal section of a sealing element 30 according to an embodiment of the invention. The sealing element 30, which can be designed without a seal carrier, has two sealing surfaces 19, 22, which are provided for contact with each of the two housing parts 109, 110, against which the sealing element 30 rests, as shown in FIGS. 3 and 4. The two sealing surfaces 19, 22 run at least in sections inclined to a longitudinal axis L of the filter element 10 (see FIG. 1). In the exemplary embodiment in FIG. 2, the two sealing surfaces 19, 22 are part of the outer surface of the sealing element 30 which is in the form of a ring torus. The sealing element 30 itself is designed in the form of a base part 80 which has two axial projections 82. An expansion of the sealing element 30 in the uncompressed state is thus greater in the axial direction than an expansion of the sealing element 32 in the radial direction. The inner surface 18 of the sealing element 30 is designed, for example, as a holding contour 26, as shown in FIG. 3, for interlocking with a counter-contour 36 on an abutment side 34 of an end plate 16 in order to fix the sealing element 30 in the longitudinal direction L of the filter element 10 on the end plate 16 fix. FIG. 3 shows a schematic sectional illustration of a filter system 100 with a focus on the sealing element 30 in the uncompressed state. The sealing element 30 in the form of a molded seal 32 is arranged on the contact side 34 of the end plate 16 with its holding contour 26 in the counter-contour 36 provided in the end plate 16. The sealing element 30 comprises an elastic sealing material and has two sealing surfaces 19, 22 for abutment on the two housing parts 109, 110, the sealing surface 22 being curved in order to abut sealingly against the corresponding component sealing surface 62, which has an angled shape. The state of the filter system 100, which is shown in FIG. 3, corresponds to a filter element 10 installed in the first housing part 109, in which the sealing surface 22 just abuts the component sealing surface 62 of the first housing part 109, while the second housing part 110 is not yet connected to the first housing part 109, so that the sealing surface 19 of the sealing element 30 and the component sealing surface 64 of the second housing part 110 are separated by a gap.

Furthermore, it can be seen that the intended lower end plate 16 has a contact surface 17 for axial contact with a contact surface 63 of one of the housing parts 109, which is offset radially inwards relative to the elastic sealing material of the sealing element 30. The contact surface 17 is provided on the outer end face of the intended lower end plate 16.

FIG. 4 shows the sealing element 30 in the compressed state in the schematic sectional illustration of the filter system 100 from FIG. 3. The second housing part 110 is fixedly connected to the first housing part 109, for example screwed, so that the sealing element 30 is pressed axially and radially in the installed state when the filter housing 108 is closed. The sealing surface 22 abuts tightly against the component sealing surface 62 of the first housing part 109, while the sealing surface 19 abuts against the component sealing surface 64 of the second housing part 110, so that a deformation of the sealing element 30 can be seen. Both the clean side 70 is thus sealed against the raw side 72 of the filter system 100 and the two housing parts 109, 110 against one another and against the environment 122, as shown in FIG. 1.

Through the contact surface 17, the end face of the intended lower end plate 16 comes into contact with the contact surface 63 of the housing part 109 and can thus limit an axial movement of the filter element 10 (FIG. 1). Such a movement can be caused by a pressure difference between the raw side and the clean side of the filter element 10.

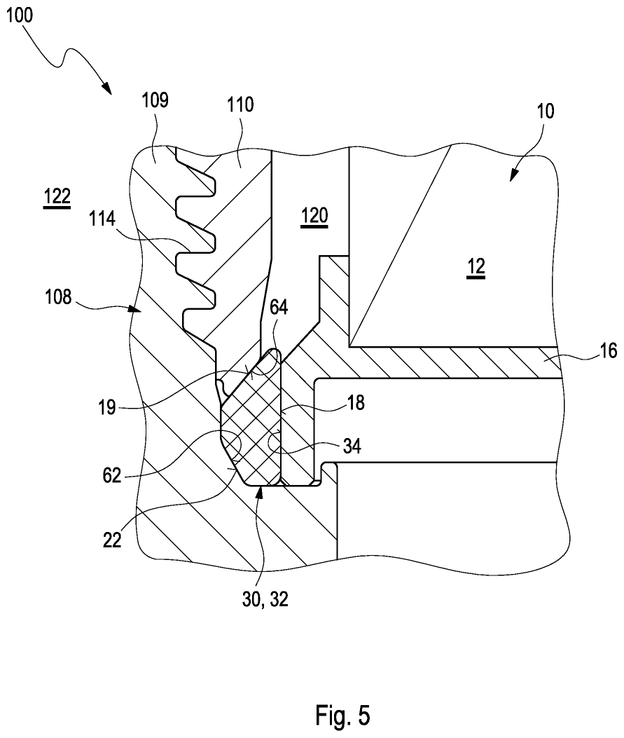

FIG. 5 shows a longitudinal section of a filter system 100 according to a further exemplary embodiment of the invention with a focus on the sealing element 30. The two housing parts 109, 110 of the filter housing 108 are shown connected to one another, so that the sealing element 30 in the form of a molded seal 32 abuts firmly with its sealing surfaces 19, 22 against the corresponding component sealing surfaces 64, 62. The inner surface 18 of the sealing element 30 is firmly connected to the contact side 34 of the end plate 16. The sealing element 30 can, for example, be glued to the contact side 34 of the end plate 16. In particular, the sealing element 30 can be vulcanized onto the contact side 34 and thus be permanently and reliably connected to the contact side 34, so that the sealing element 30 does not change its position even when the filter element 10 is mounted with the end plate 16 in the filter housing 108 or slip when inserted.

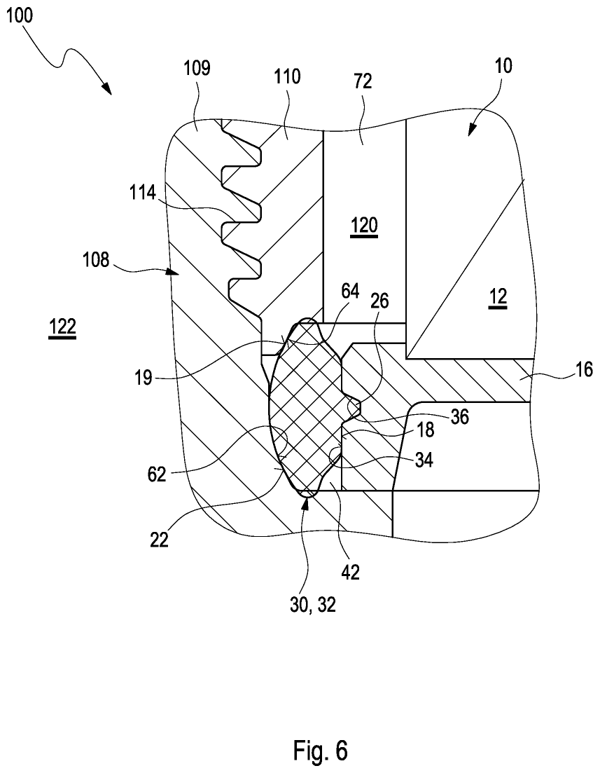

FIG. 6 shows a longitudinal section of a filter system 100 with a filter element 10 inserted according to a further exemplary embodiment of the invention, with a focus on the sealing element 30. In this exemplary embodiment, the sealing element 30 is also arranged directly on the contact side 34 of the end plate 16, but has a point-shaped holding contour 26 which engages in a correspondingly groove-shaped counter-contour 36 of the end plate 16, so that the sealing element 30 is connected to the end plate 16, in particular connected captively, and its axial position does not change when the filter element 10 is inserted into the filter housing 108. In addition, the sealing element 30 can be glued or vulcanized to the end plate 16, for example. The radially outer shape of the sealing element 30 with its sealing surfaces 19, 22 is crescent-shaped, the sealing element 30 being pressed axially and radially when the two housing parts 109, 110 are closed and the cross section of the sealing element 30 thus adapting to the corresponding component sealing surfaces 64, 62 and abutting sealingly against it. In this exemplary embodiment, the sealing element 30 partially protrudes from a sealing groove 42 of the first housing part 109. With this arrangement of the sealing element 30, a secure and reliable sealing of the raw side 72 of the filter system 100 against the clean side 70 and of the two housing parts 109, 110 against the environment 122 is ensured.

What is claimed is:

1. A filter element assembly adapted for filtering fuel or other fluids, comprising:
a filter element having
an annular filter bellows surrounding a longitudinal axis (L), the annular filter bellow configured to be flowed through in a radial direction and having two axially opposing end faces;
at least one end plate arranged at least one of on the axial end faces of the annular filter bellows; and
at least one circumferential sealing element arranged on the end plate;
wherein the sealing element, when installed in a filter system, is adapted to seal between the filter element and a housing of the filter system, sealing a clean side of the filter element from a raw side of the filter element;
wherein the sealing element, when installed in the housing, is compressed between a first housing part and a second housing part of the filter system, sealing a housing interior of the filter system from an environment of the filter system.

2. The filter element assembly according to claim 1, wherein
the sealing element is arranged on a lower end plate of the at least one end plate.

3. The filter element assembly according to claim 2, wherein
the lower end plate further includes a water discharge opening for separated water.

4. The filter element assembly according to claim 2, wherein
a further sealing element for sealing between the clean side and the raw side is provided in the region of the axial the axial end face of the filter bellows which is opposite the lower end plate.

5. The filter element assembly according to claim 3, wherein
the sealing element on the lower end plate seals a clean-side water collection space from the raw side.

6. The filter element assembly according to claim 1, wherein
the lower end plate has a contact surface adapted for axial contact against one of the housing parts, the contact surface is offset radially inward on the lower end plate relative to an elastic sealing material of the sealing element;
wherein the contact surface is provided on an outer end face of the lower end plate.

7. The filter element assembly according to claim 2, wherein
the sealing element is captively connected to the end plate.

8. The filter element assembly according to claim 1, wherein
the end plate has a radially outer contact surface;
the sealing element has at least one radially inner surface which lies sealingly against the radially outer contact surface of the end plate;
wherein the sealing element is formed without a seal carrier.

9. The filter element assembly according to claim 8, wherein
the sealing element has at least two sealing surfaces which, in an installed state of the filter element, each contact a respective one of the two housing parts.

10. The filter element assembly according to claim 9, wherein
the two sealing surfaces extend at least in sections inclined to the longitudinal axis (L) of the filter element.

11. The filter element assembly according to claim 9, wherein
an expansion of the sealing element in an uncompressed state in the axial direction is greater than an expansion of the sealing element in the radial direction.

12. The filter element assembly according to claim 8, wherein
the at least one radially inner surface of the sealing element is fixedly connected to the radially outer contact surface of the end plate,
wherein the sealing element is vulcanized to the radially outer contact surface.

13. The filter element assembly according to claim 8, wherein
the sealing element on the at least one radially inner surface has at least one holding contour fixing the sealing element onto the radially outer contact surface,
wherein the at least one holding contour engages in a corresponding counter-contour of the radially outer contact surface.

14. A filter system for filtering a fluid, comprising:
a filter housing comprising:
a first housing part; and
a second housing part;
a filter element assembly having:
a filter element arranged in the filter housing in at least one of the housing parts. the filter element comprising:
an annular filter bellows surrounding a longitudinal axis (L), the annular filter bellow configured to be flowed through in a radial direction and having two axially opposing end faces;
at least one end plate arranged at least one of on the axial end faces of the annular filter bellows; and
at least one circumferential sealing element arranged on the end plate;
wherein the sealing element, when installed in the filter housing, seals between the filter element and the filter housing of the filter system, sealing a clean side of the filter element from a raw side of the filter element;
wherein the sealing element, when installed in the filter housing, is compressed between the first housing part and the second housing part of the filter system, sealing a housing interior of the filter system from an environment of the filter system.
wherein the sealing element is arranged on a radially outer contact surface of a lower end plate of the at least one end plate;
wherein the contact surface is offset radially inward on the lower end plate relative to an elastic sealing material of the sealing element;
wherein the sealing element is under compression between the first housing part and the second housing part, sealing a housing interior of the filter system from an environment of the filter system.

15. The filter system according to claim 14, wherein
in the installed state in the filter housing, the sealing element is pressed axially and radially by the filter housing when the filter housing is closed.

16. The filter system according to claim 15, wherein
the sealing element is chambered between the first housing part, the second housing part and the lower end plate.

17. The filter system according to claim 16, wherein
the sealing element protrudes in the axial direction away from a sealing groove of the first and/or second housing part.

18. The filter system according to claim 16, wherein
the sealing element has a base part and at least one axial projection;
wherein the base part abuts via the radially inner surface against the radially outer contact surface of the lower end disk and is supported radially inwards from the contact surface;
wherein the radially inner surface, in the compressed state of the sealing element, has an axial extent of at least 50% of an uncompressed axial extent of the sealing element.

19. The filter system according to claim 18, wherein
the at least one axial projection abuts against a component sealing surface of the first housing part or against a component sealing surface of the second housing part.

20. The filter system according to claim 19, wherein
the component sealing surface of one of the housing parts is arranged in the axial direction outside the sealing groove of the other housing part.

21. The filter system according to claim 16, wherein
the sealing element has at least two sealing surfaces, a respective ones of one of which, is in the installed state, contacts the two housing parts.

22. The filter system according to claim 14, wherein
on the axial end face of the filter element which is opposite the lower end plate, a further sealing element is arranged that seals against the filter housing, sealing between the clean side and the raw side of the filter element.
